(19) United States
(12) Patent Application Publication
(10) Pub. No.: US 2005/0258972 A1
(43) Pub. Date: Nov. 24, 2005

(54) Reach stacker

(76) Inventor: Thomas Klimmer, St. Jakob (AT)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/122,789

(22) Filed: May 3, 2005

(30) Foreign Application Priority Data
May 4, 2004 (DE) 20 2004 007 063.4

(51) Int. Cl. G01S 1/00; G06G 7/78; G06F 17/10; G08B 21/00

(52) U.S. Cl. 340/621

(57) ABSTRACT

The present application relates to a reach stacker comprising a vehicle frame, a telescopic boom with a load-receiving means pivotably arranged thereon and an operator's cabin fixedly or movably connected to the vehicle frame and having side mirrors and/or rear view mirrors associated with it. In accordance with one embodiment, an anti-collision warning system arranged at the rear consists of a plurality of sensors, preferably ultrasonic sensors, via which an acoustic and/or visual warning device can be activated on the sensing of an obstacle.

### CROSS-REFERENCE TO RELATED APPLICATION

This application claims priority to German Patent Application Serial No. DE 202004007063.4 filed May 4, 2004, which is hereby incorporated by reference in its entirety for all purposes.

1. Field

The present application relates to mobile conveying vehicles, such as telescopic loaders and reach stackers, for example.

2. Background and Summary

Reach stackers are vehicles with rubber tires, a diesel engine and an operator's cabin. They have the capability of transporting and stacking loads, in particular containers, trailers, sheet metal coils, part loads, etc. Previously known reach stackers are fitted with a container spreader arranged as a load receiving means on the telescopic arm, i.e. a lifting and lowering of the spreader only takes place via the telescopic arm. They can handle or stack fully loaded containers in a multiple manner behind one another and on top of one another. In the known reach stacker, the operator's cabins are arranged fixedly or movably connected to the frame in the rear part on the vehicle, whereby the operator always has a good view of the container spreader fixedly connected to the telescopic arm. When reversing, the driver can ascertain through corresponding rear-view mirrors and side mirrors whether obstacles are in the reversing space region of the reach stacker.

A reach stacker 10 is shown in FIG. 1. The pivotably arranged telescopic boom with load-receiving means 12 is arranged centrally. The operator's cabin 14 is positioned laterally offset thereto. A rear-view mirror, side mirrors and a front mirror are associated with it. The resulting region visible to the operator sitting in the operator's cabin 14 is shown in hatched form. The region which is freely visible to the driver from the cabin is shown with a simple hatching. The region with double hatching shows the region which can respectively be seen through the mirrors. As can be recognized from FIG. 1, there is a non-visible region due to the structures, for example to the telescopic beam. When reversing during the operation of the reach stacker, there is the risk here that an obstacle can be overlooked and that a collision with this obstacle occurs.

It is one object of the present application to further develop a generic reach stacker to the effect that it can also be operated reliably during reversing.

This object is solved in one embodiment by a reach stacker provided in the rear region with an anti-collision warning system comprising a plurality of sensors, preferably ultrasonic sensors, via which an acoustic and/or visual warning device can be activated on the sensing of an obstacle. For example, as soon as one of the sensors recognizes an obstacle, the corresponding control reports a visual and/or acoustic warning to the operator of the reach stacker so that he can react and can stop the reach stacker in order to prevent a collision with the obstacle discovered.

Additional features and advantages are discussed below.

For example, when using ultrasonic sensors, they may be advantageously arranged in the rear region in the body. In one embodiment, they can be arranged at the lower rear side of the reach stacker, with it, however, having to be prevented that they recognize the road surface or irregularities of the road surface as an obstacle.

In accordance with a further advantageous aspect, at least three ultrasonic sensors are arranged in the rear region. At least one ultrasonic sensor of these is advantageously directed to the rear in the rear region, whereas at least one sensor is directed to the side. A further reversing space region can hereby be sensed. In a very particularly advantageous manner, three ultrasonic sensors are directed to the rear in the rear region, while two respective sensors are directed to the side. The ultrasonic sensors are arranged in the body approximately equidistant from one another and ensure an uninterrupted monitoring of the reversing space region.

In accordance with another advantageous aspect, the anti-collision warning system by means of these ultrasonic sensors can be combined with other systems, advantageously a radar system.

Finally, the anti-collision warning system can be made as a retrofit kit.

### BRIEF DESCRIPTION OF THE FIGURES

Further features, details and advantages result from an embodiment shown in the drawings.

FIG. 1 shows a reach stacker with a reversing space monitoring according to the prior art which is only achieved by mirrors; and

FIG. 2: a reach stacker with an anti-collision warning system in accordance with the present application.

### DETAILED DESCRIPTION

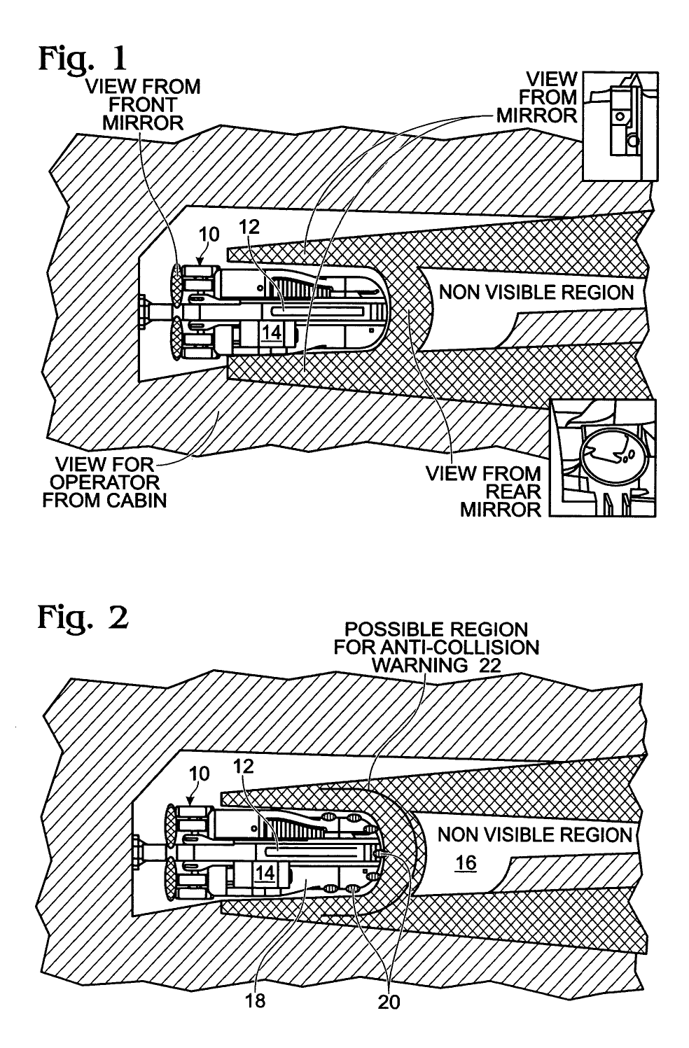

A reach stacker 10 is shown in FIG. 2 which has a pivotably arranged telescopic boom 12 centrally next to which an operator's cabin 14 is fixedly or movably connected to the vehicle frame. The regions visible using a rear-view mirror and side mirrors not shown in any more detail here are hatched in the same manner as in FIG. 1 discussed in the introduction. The region 16 which is bordered and not hatched here and is not visible to the operator sitting in the operator's cabin 14 is likewise shown.

In accordance with the present application, the anti-collision warning system in accordance is integrated in the rear region of the body 18. For this purpose, a series of ultrasonic sensors 20 are attached to the lower rear side in an arrangement shown in accordance with FIG. 2. Three sensors 20 are directed to the rear in the direct rear region. Two respective sensors are directed to the side in the rear region. Note that sensors 20 may be various types of sensors other than an ultrasonic type.

The ultrasonic sensors 20 have a range of up to 7 meters in which they recognize objects. These sensors operate such that they transmit ultrasonic pulses. If an object is now located inside the range of the sensors, it will reflect the ultrasonic rays. The reflections are measured by the sensors 20 and evaluated as a signal.

The sensors cover a defined collision region at the rear side of the unit, said region being drawn here by a solid line as a possible region for anti-collision warning 22 in FIG. 2.

As soon as an obstacle is recognized by the sensors 20, the control reports a visual and/or acoustic warning to the operator of the unit. He can then react and stop the reach stacker 10.

The more sensors are used for the sensing of the region, the larger this region in which obstacles are recognized can become. Seven sensors are advantageously shown, as illustrated in FIG. 2.

1. A reach stacker comprising a vehicle frame, a telescopic boom with a load-receiving means pivotably arranged thereon and an operator's cabin fixedly or movably connected to the vehicle frame and having side mirrors or rear view mirrors associated with it, and an anti-collision warning system arranged at a rear of the stacker, the warning system comprising a plurality of sensors, via which an acoustic or visual warning device can be activated on sensing of an obstacle.

2. A reach stacker in accordance with claim 1, wherein the sensors are arranged in the rear region in the body.

3. A reach stacker in accordance with claim 2, wherein at least three ultrasonic sensors are arranged in the rear region.

4. A reach stacker in accordance with claim 3, wherein at least one ultrasonic sensor is directed to a rear in the rear region and wherein at least one respective sensor is directed to a side.

5. A reach stacker in accordance with claim 4, wherein three ultrasonic sensors are directed to the rear in the rear region and wherein at least two respective sensors are directed to the side.

6. A reach stacker in accordance with claim 1, wherein the anti-collision warning system comprising a plurality of ultrasonic sensors is combined with a radar system.

7. A retrofit kit configured to be coupled to a reach stacker having a vehicle frame, a telescopic boom with a load-receiving member pivotably arranged thereon and an operator's cabin fixedly or movably connected to the vehicle frame, the kit comprising:
an anti-collision warning system configured to be coupled to a rear of the stacker, the warning system comprising a plurality of sensors and a warning device, where an acoustic or visual signal of the warning device can be activated on the sensing of an obstacle via said plurality of sensors.

8. The kit according to claim 7, wherein at least one of the plurality of sensors is an ultrasonic sensor.

9. The kit according to claim 8, wherein at least one of the plurality of sensors is configured to be directed to a side of the stacker.

10. The kit according to claim 8, wherein at least one of the plurality of sensors is configured to be directed to a rear of the stacker.

11. A reach stacker, comprising:
a vehicle frame;
a telescopic boom;
an operator's cabin fixedly or movably connected to the vehicle frame and having side mirrors and rear view mirrors associated with it; and
an anti-collision warning system arranged at a rear of the stacker, the warning system comprising a plurality of sensors, via which an acoustic or visual warning device can be activated on sensing of an obstacle that may otherwise be obstructed from viewing in the mirrors by said telescopic boom.

12. A reach stacker in accordance with claim 11, wherein the sensors are arranged in the lower rear region in the body.

13. A reach stacker in accordance with claim 12, wherein at least three ultrasonic sensors are arranged in the rear region.

14. A reach stacker in accordance with claim 13, wherein at least one ultrasonic sensor is directed to a rear in the rear region and wherein at least one respective sensor is directed to a side.

15. A reach stacker in accordance with claim 14, wherein three ultrasonic sensors are directed to the rear in the rear region and wherein at least two respective sensors are directed to the side.

16. A reach stacker in accordance with claim 11, wherein the anti-collision warning system comprising a plurality of ultrasonic sensors is combined with a radar system.
